(19) United States
(12) Patent Application Publication
(10) Pub. No.: US 2013/0025559 A1
(43) Pub. Date: Jan. 31, 2013

(54) HIGH PRESSURE DIE CASTING FLASH CONTAINMENT SYSTEM

(71) Applicant: Matthew Pettus, Botkins, OH (US)

(72) Inventor: Matthew Pettus, Botkins, OH (US)

(73) Assignee: HONDA MOTOR CO., LTD., Tokyo (JP)

(21) Appl. No.: 13/492,497

(22) Filed: Jun. 8, 2012

Related U.S. Application Data
(60) Provisional application No. 61/495,814, filed on Jun. 10, 2011.

(51) Int. Cl. B22C 9/22; F02F 1/00; B32B 15/02

(52) U.S. Cl. 123/193.2; 164/332; 428/586

(57) ABSTRACT

Devices for sealing the gap between a bore pin and an insert (e.g., sleeve) during the casting of, for example, internal combustion engine cylinder blocks. Such devices incorporate a sealing ring set that may be set into a recessed channel about a circumference of the bore pin. Radial force on the ring provides a seal between the bore pin and the sleeve that prevents flash from entering gaps therebetween. The ring may take on any of a number of different configurations and the outward force may be generated in various ways—including from the tension of the ring itself.

### CROSS-REFERENCE TO RELATED APPLICATIONS

This application claims the benefit of U.S. Provisional Application No. 61/495,814, which was filed on Jun. 10, 2011 and is incorporated by reference herein.

### TECHNICAL FIELD

The present invention is directed to the field of metal casting and, more particularly, to improved devices for engine block casting.

### BACKGROUND

In the process of producing die castings, there is often a need to place cores or inserts into the mold cavity to facilitate casting. This mold cavity is often made up of a different material than the core or insert. One problem associated with the use of inserts is imperfect registration between the insert and the mold, which results in tiny differences between the two surfaces that allow minute metal particles termed “flash” or “flashing to develop in the unoccupied space.

Flash or flashing also occurs when flowing metal penetrates the fine cracks that can develop in a mold. Metal penetration causes a rough surface or fin-like edge to be raised on the surface of a cast part—although in extreme cases, molten metal can push right through the refractory wall and rupture the mold. Flashing can also flow into any cracks in the internal core mass, leading to difficulties in extracting core refractory from the cast's cavity. The amount and severity of the flashing is dependent on the tolerances between the die and insert, the temperatures required for the process, and the thermal expansion coefficients of the materials used.

Most flash can be removed, however, flashing nonetheless results in a loss of casting material and wasted time for operators. The materials that make up flash are often not recoverable for reuse as they may be contaminated from the casting and removal process. Most applications, automotive casting among them, will require that the flash be removed—necessitating operator time and effort to bring the die-cast piece up to the required quality standard.

During the process of casting metal engine blocks, and in particular casting of the cylinder barrel, a sleeve is often cast in the cylinder. To facilitate casting of the sleeve, a bore pin is provided and the sleeve is fitted on an outer surface of the bore pin. Depending on the temperatures and pressures that occur during the casting process, metal may flash between the bore pin and the sleeve. When flashing is present between an insert in the mold, there is the potential of distortion of the insert due to the high pressures of the process. Depending on the severity of the flashing and subsequent distortion, this may result in a part that is rejected due to lack of proper wall thickness after machining. Prior methods to control this flashing include reducing the tolerance between the inner diameter of the sleeve and the outer diameter of the bore pin. This technique has limits though, as a single bore pin will be generally engaged with and disengaged from a number of sleeves, and reducing the tolerances may increase generated pressures between the two pieces that can lead to increased machine down time.

### SUMMARY

This and other unmet needs of the prior art are met by devices and methods as described in more detail below.

In an exemplary embodiment of the invention, a casting mold device includes a sleeve, a bore pin for supporting the sleeve and a ring to provide tighter engagement between the sleeve and the bore pin. The bore pin may include a recess about an outer surface to accommodate the ring when not engaged with the sleeve. In an exemplary embodiment, the recess is a circumferential recess approximating the thickness of the ring. The device may further include a force generating means for creating pressure on an inside surface of the ring to provide a tighter seal between the bore pin and the sleeve.

Flash elimination arrangements and devices provided herein will interlock with a mold and or bore pin to remain within the mold for multiple shots. Exemplary embodiments include a split ring design with spring qualities that will provide spring pressure on the insert. The spring design will accommodate the variability in tolerances between the mold and insert to provide a repeatable sealing surface to eliminate flashing. Embodiments of the invention may also incorporate a chamfer on the leading edge of the ring to allow for repeated insertion of the insert onto the die via mechanical or human interface methods.

### BRIEF DESCRIPTION OF THE DRAWINGS

A better understanding of the exemplary embodiments of the invention will be had when reference is made to the accompanying drawings, wherein identical parts are identified with identical reference numerals, and wherein:

FIG. 1 is a drawing of a prior art bore pin and sleeve assembly.

FIG. 2 is a cross-sectional side view of an exemplary bore pin and ring arrangement;

FIG. 3 is a side view of an exemplary bore pin and ring arrangement;

FIG. 4 is a schematic view of a bore pin and sleeve arrangement;

FIG. 5 is illustrates an exemplary bore pin and sleeve arrangement including a sealing ring;

FIG. 6 is a top view of an exemplary bore pin with a sealing ring;

FIG. 7 shows an exemplary embodiment of a bore pin and ring arrangement;

FIG. 8 is shows an exemplary embodiment of a bore pin and ring arrangement;

FIG. 9 shows an exemplary embodiment of a bore pin and ring arrangement;

FIG. 10 schematically represents an exemplary embodiment of a ring;

FIG. 11 is schematically represents an exemplary embodiment of a ring; and

FIG. 12 schematically represents an exemplary embodiment of a bore pin and ring arrangement.

### DETAILED DESCRIPTION

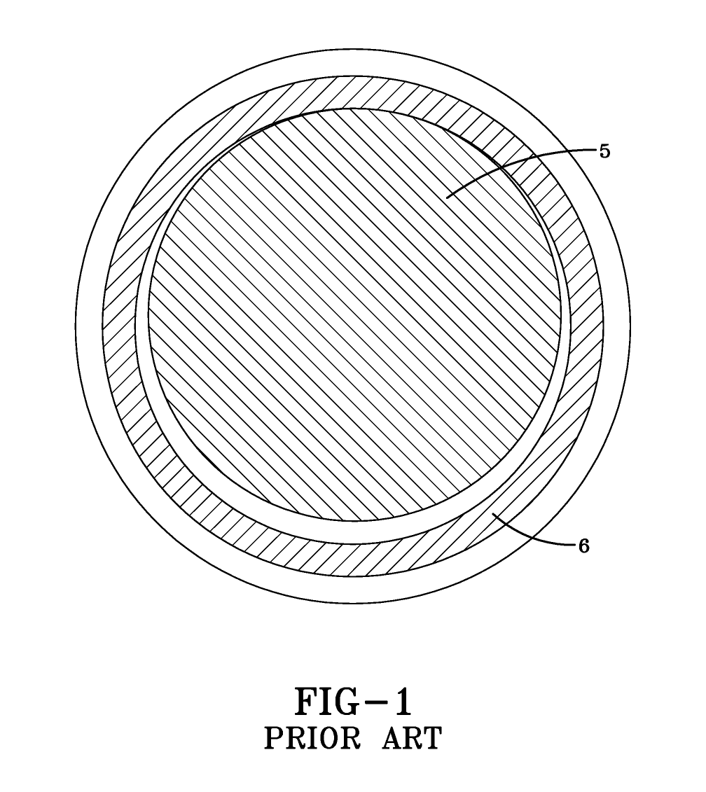

FIG. 1 shows a conventional bore pin 5 and sleeve 6 arrangement. This figure demonstrates that even with tight tolerances, there is room for flash to penetrate spaces between the components. The two components are shown to be misaligned in FIG. 1. However, flash occurs regardless of proper alignment so long as there is sufficient space between the components.

Flash control devices must be able to withstand the high temperatures and pressures generated during metal casting and yet provide a tight seal between the bore pin and the sleeve insert. A flash control device that comprises a one-piece metallic sealing ring can provide these features. The ring may be a one-piece split ring recessed into a die component. Flash control springs may be used to provide sufficient pressure against the insert sleeve to create a seal that prevents flash from developing, while still allowing for repeatable insertion of the insert. In order to facilitate this repeated insertion, the ring may include a chamfer or similar feature on its leading edge to help compress the ring during insertion.

Engine block casting dies typically utilize a cylinder liner or sleeve that is inserted into the die on each shot. Depending on the model and the state of the art there may be three types of sleeves inserted onto a bore pin: a mass production iron sleeve, a mass production aluminum sleeve, and a pre-heat aluminum sleeve.

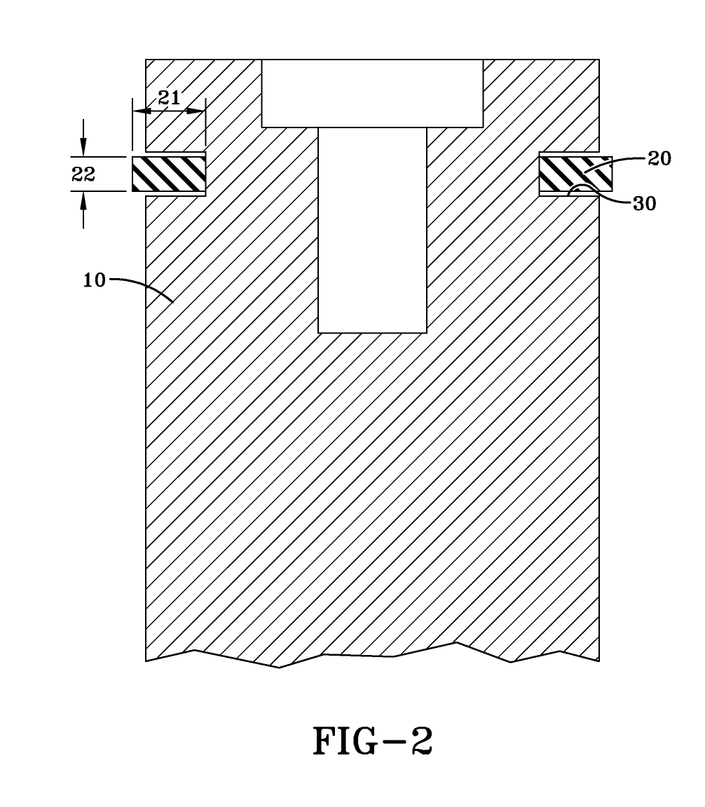

FIG. 2 shows a cross-section of an exemplary bore pin 10 and sealing ring 20 arrangement according to the invention. It is clear from the drawing that the ring sits in a recess 30 of the bore pin in this embodiment. The recess is essentially a channel that traces the circumference of the bore pin. The recess has a smaller diameter than the remainder of the bore pin. The difference in diameter need only be large enough to accommodate the width 21 of the ring when the bore pin is engaged with the sleeve. The height of the recess is preferably sufficient to accommodate the height 22 of the ring. The ring material is chosen based on the high temperature and pressures associated with metal castings, and specifically for contact with molten metal (e.g., aluminum). Tolerancing between the die groove and ring will serve to further control flashing.

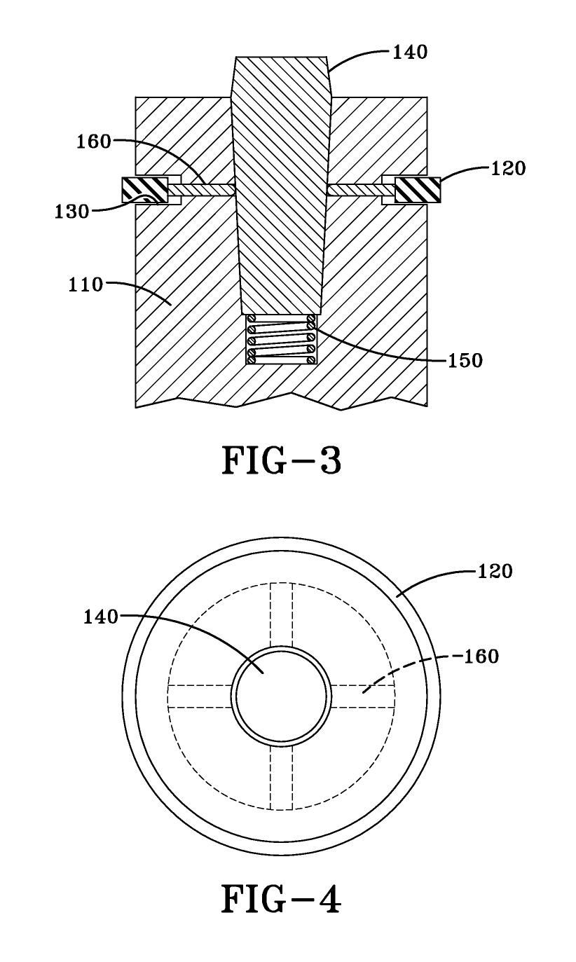

FIG. 3 shows a cross-sectional side view of another embodiment of a bore pin 110 and sealing ring 120 arrangement. Here an actuator 140 is provided for engaging the ring with the sleeve. The actuator 140 has a tapered shape such that movement of the actuator into the bore pin forces the ring outward from the recess. The arrangement may further include a return force-generating means 150. The return force-generating means provides an actuator disengaging force that allows the ring to return to the recess. Additionally, the arrangement may include one or more elements 160 for transferring force from the actuator to the ring. Flash control springs may be employed to herein provide sufficient pressure against the insert sleeve to create a seal that prevents flash from developing, while still allowing for repeatable insertion of the insert. In order to facilitate this repeated insertion, the ring may include a chamfer or a similar feature on its leading edge that helps to compress the ring during insertion. Tolerance reduction and or mechanical sealing between the die groove and ring will serve to further control flashing.

FIG. 4 is a top view of the embodiment of FIG. 3. In this view, the sealing ring 120 is shown with four force transferring elements 160 radially positioned about the actuator 140 for applying force to the ring. Although this embodiment is shown with four force transferring elements, practitioners will readily recognize that other variations or combinations of force transferring elements may be equally or adequately effective and, thus, the arrangement shown is meant to be illustrative rather than limiting.

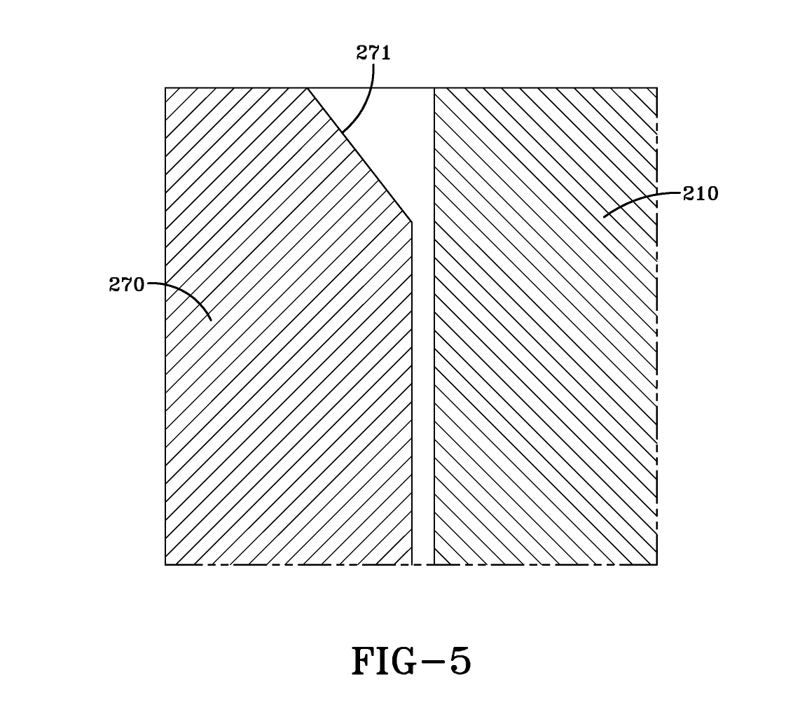

FIG. 5 is an enlarged cross-sectional view showing a portion of an exemplary sleeve over bore pin arrangement. The sleeve 270 may include a chamfer 271 on its leading edge to facilitate insertion of the sleeve over the bore pin 210.

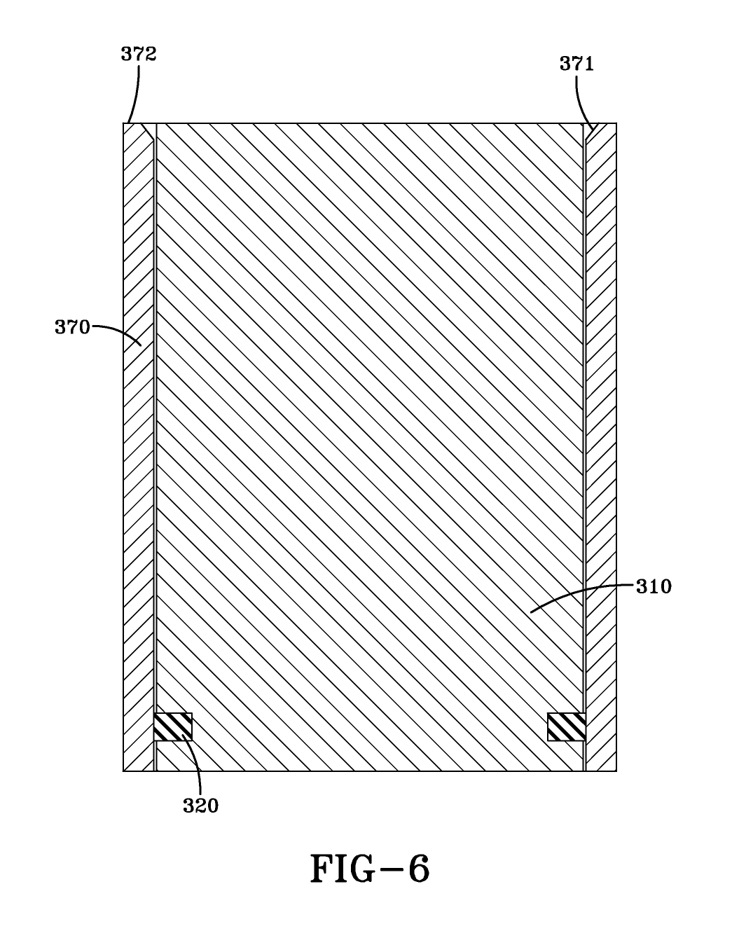

FIG. 6 shows an exemplary embodiment of a sleeve located around a bore pin and sealing ring according to the invention. The sleeve 370 is inserted over the bore pin 310, leading edge 372 first. As in FIG. 5, the sleeve may include a chamfer 371 or similar feature on the leading edge thereof to facilitate installation of the sleeve over the bore pin. Moreover, the chamfer may facilitate installation of the sleeve over the sealing ring 320, as the tapered surface of the chamfer acts to apply a gradual compressing force to the ring as the sleeve is inserted over the bore pin. Compression of the ring allows the arrangement to achieve a tighter seal.

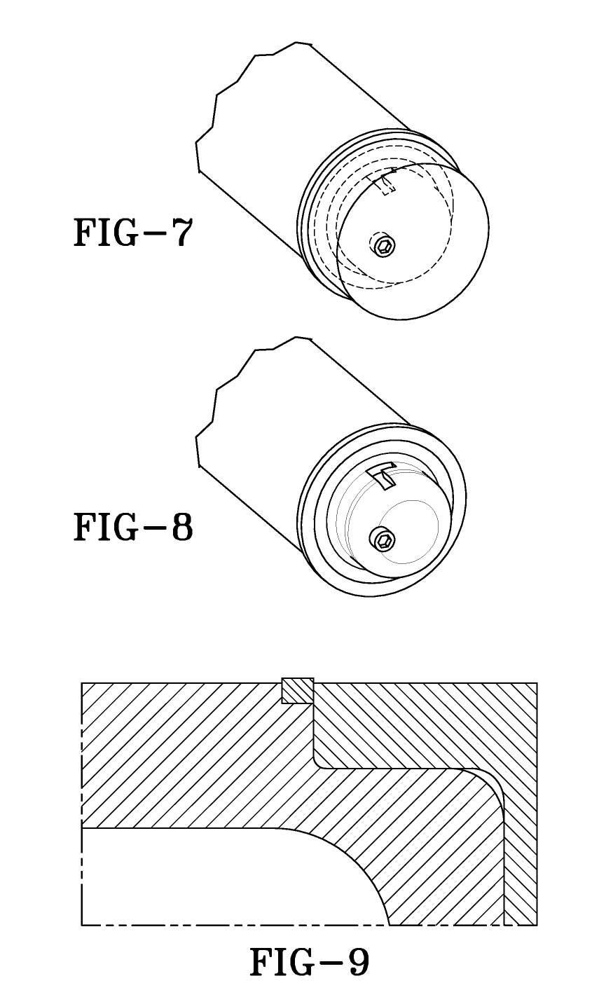

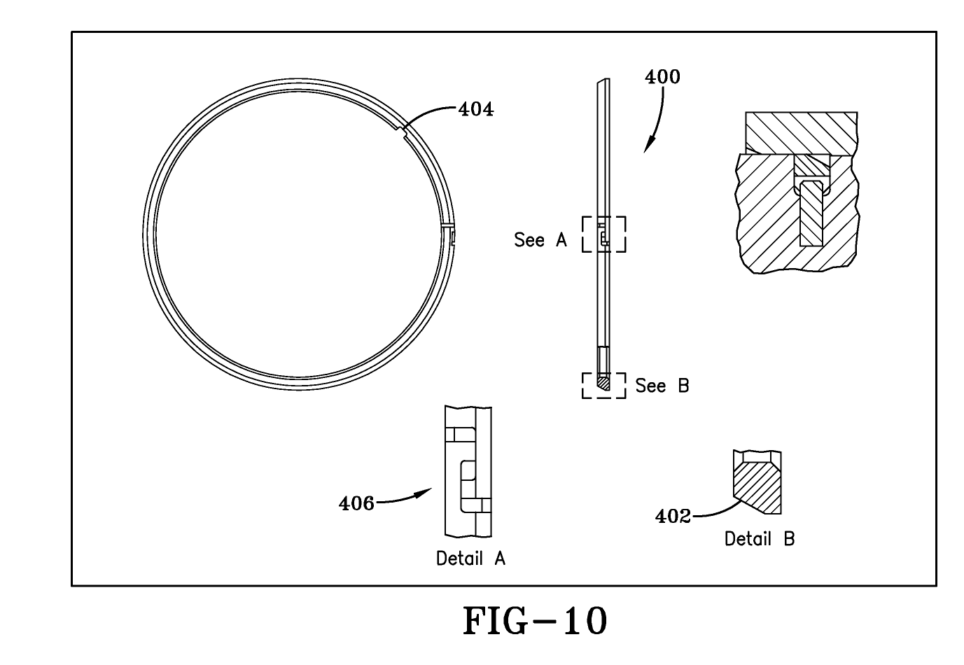

FIGS. 7-9 show an embodiment of a two-piece bore pin and sealing ring arrangement. The cap section of the bore pin mates in a locking registration with the main bore pin body to aid in retaining the sealing ring in proper position.

FIG. 10 schematically depicts an exemplary embodiment of a ring that may be used according to the invention. This figure reveals additional details of alternative possible features of an exemplary ring 400, such as a tapered or chamfered sealing edge 402 and a rotation preventing notch 404 that may be provided to engage a complimentary feature on the bore pin. This particular ring is also of split design, but includes overlapping interlock elements 406 that limit ring expansion while facilitating ring compression and sealing capability.

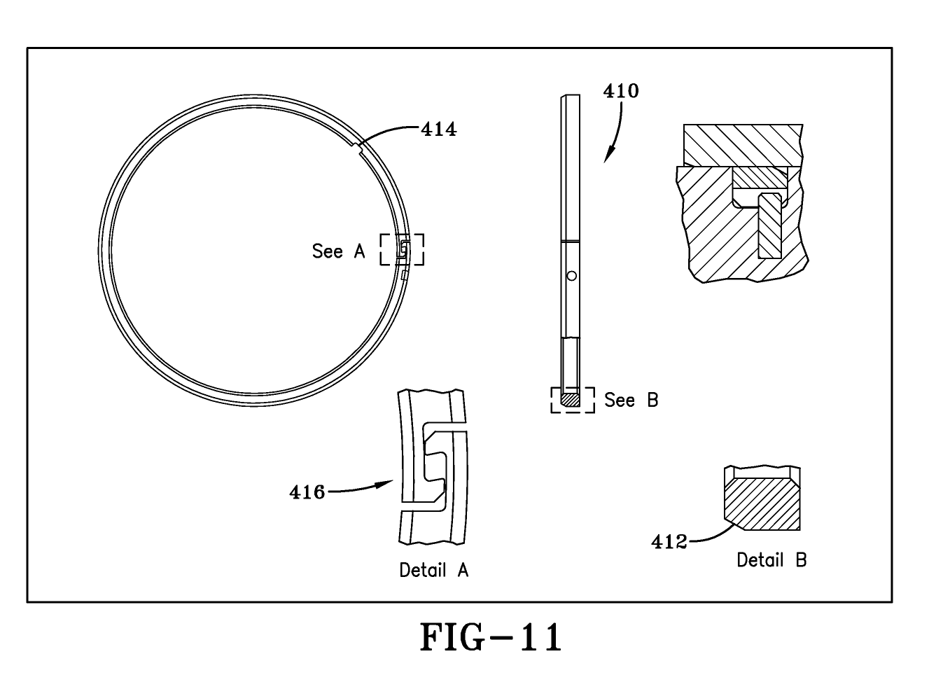

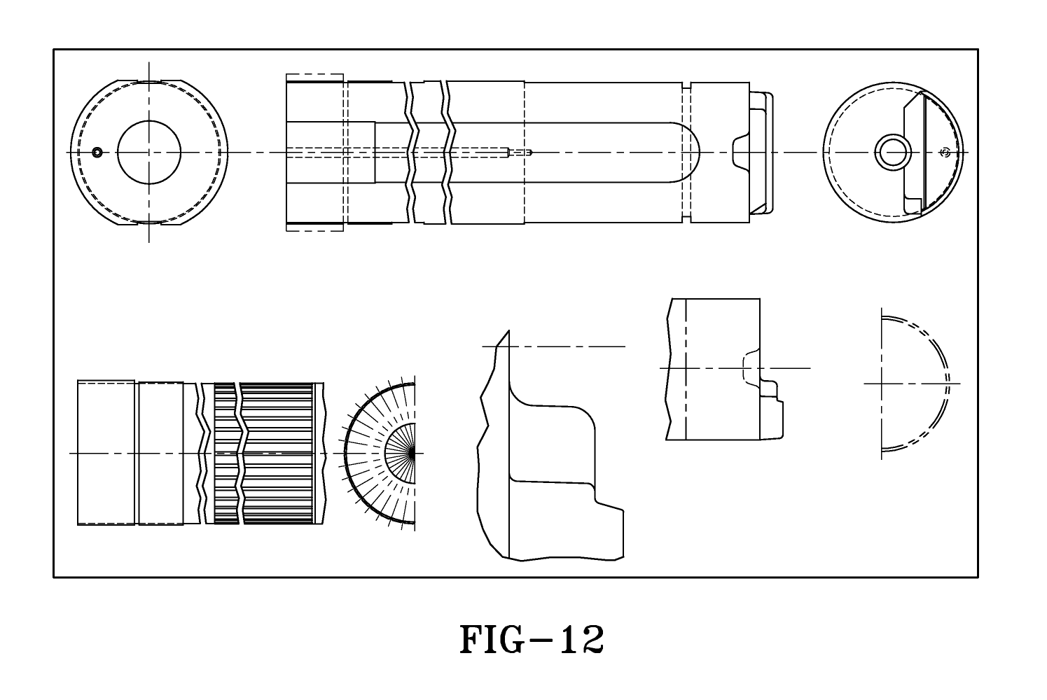

FIG. 11 schematically depicts another alternative embodiment of a ring 410. As with the ring 400 of FIG. 10, this ring may have a tapered or chamfered sealing edge 412 and a rotation preventing notch 414 that may be provided to engage a complimentary feature on the bore pin. This particular ring is also of split design, but includes overlapping interlock elements 416 that differ from the interlock elements 406 of the ring 400 of FIG. 10. The interlock elements 416 limit ring expansion while facilitating ring compression and sealing capability.

The split ring designs shown in FIG. 10 and FIG. 11 allow the rings 400, 410 to provide outward spring tension when the ends are mated, thereby providing spring pressure on the insert. Such a flash control device provides sufficient pressure against the insert sleeve to create a seal that prevents flash from developing, but still allows for repeatable insertion of the insert. In order to facilitate this repeated insertion, the ring may include a chamfer or similar feature on its leading edge (as shown). The chamfer or similar feature helps to compress the ring during installation of an associated sleeve.

FIG. 12 schematically illustrates an alternative embodiment of a bore pin and ring arrangement. Several optional features of the bore pin and ring are shown. For example, and without limitation, the bore pin may be splined and/or include various engaging/mating elements at its distal (free) end.

The terms “a” and “an” and “the” and similar references used in the context of describing the disclosed embodiments (especially in the context of the following claims) are to be construed to cover both the singular and the plural, unless otherwise indicated herein or clearly contradicted by context.

Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the disclosed embodiments and does not pose a limitation on the scope of the disclosed embodiments unless otherwise claimed. No language in the specification should be construed as indicating any non-claimed element essential to the practice of the disclosed embodiments or any variants thereof.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability

Various exemplary embodiments of the invention are described herein, including the best mode known to the inventors for carrying out the invention(s). It is expected that variations of said exemplary embodiments may become apparent to those of ordinary skill in the art upon reading the foregoing description. Accordingly, this disclosure includes all modifications and equivalents of the subject matter recited in the claims appended hereto. Moreover, any combination of the above described elements in all possible variations thereof is encompassed by the disclosed embodiments unless otherwise indicated herein or otherwise clearly contradicted by context. Therefore, while certain embodiments of the present invention are described in detail above, the scope of the invention is not to be considered limited by such disclosure, and modifications are possible without departing from the spirit of the invention as evidenced by the following claims:

What is clamed is:

1. An insert arrangement for molding into an metal casting, the insert arrangement comprising:
a hollow metallic insert of some cross-sectional shape;
a removable metallic bore pin having a cross-sectional shape that corresponds to the cross-sectional shape of the insert, the bore pin having an outer dimension(s) that permits installation of the bore pin into the insert; and
a sealing ring encircling the exterior of the bore pin, the ring arranged and dimensioned so as to be pressed against an inner wall of the insert in a sealing manner when the bore pin is installed into the insert.

2. The insert arrangement of claim 1, wherein the insert is a cylinder bore lining sleeve for an internal combustion engine.

3. The insert arrangement of claim 1, wherein the bore pin includes an exterior groove and the sealing ring resides at least partially within the groove.

4. The insert arrangement of claim 1, wherein the sealing ring is of split design.

5. The insert arrangement of claim 4, wherein the sealing ring includes interlocking elements at the location of the spilt, the interlocking elements permitting but limiting compression and expansion of the sealing ring.

6. The insert arrangement of claim 1, wherein the sealing ring includes an anti-rotation element that engages a corresponding element on the bore pin when the sealing ring is installed thereto.

7. The insert arrangement of claim 1, wherein a leading edge of the insert includes a chamfer or taper.

8. The insert arrangement of claim 1, further comprising an actuator that moves within an axial bore in the bore pin, the actuator engaging an inner wall of the sealing ring and adapted to expand the sealing ring as the actuator is moved further into the bore pin.

9. The insert arrangement of claim 8, further comprising a plurality of force transferring elements radially positioned between the actuator and the sealing ring.

10. The insert arrangement of claim 8, further comprising an actuator return mechanism adapted to move the actuator away from a position of sealing ring expansion.

11. A sleeve arrangement for molding into an metal casting, the sleeve arrangement comprising:
a metallic sleeve of hollow cylindrical shape;
a removable metallic bore pin of cylindrical shape, the bore pin having an outer diameter of a dimension that permits installation of the bore pin into the sleeve; and
a sealing ring encircling the outer diameter of the bore pin, the sealing ring arranged and dimensioned so as to be pressed against an inner wall of the sleeve in a sealing manner when the bore pin is installed into the sleeve.

12. The sleeve arrangement of claim 11, wherein the sleeve is a cylinder bore lining sleeve for an internal combustion engine.

13. The sleeve arrangement of claim 11, wherein the bore pin includes a circumferential groove and the sealing ring resides at least partially within the groove.

14. The sleeve arrangement of claim 11, wherein the sealing ring is of split design and includes interlocking elements at the location of the spilt, the interlocking elements permitting but limiting circumferential compression and expansion of the sealing ring.

15. The sleeve arrangement of claim 11, wherein the sealing ring includes an anti-rotation element that engages a corresponding element on the bore pin when the sealing ring is installed thereto.

16. The sleeve arrangement of claim 11, wherein a leading edge of the sleeve includes a chamfer or taper.

17. The sleeve arrangement of claim 11, further comprising an actuator that moves within an axial bore in the bore pin and is adapted to engage and circumferentially expand the sealing ring as the actuator is moved further into the bore pin, an actuator return mechanism located within the bore pin and adapted to move the actuator away from a position of sealing ring expansion.

18. The sleeve arrangement of claim 17, further comprising a plurality of force transferring elements radially positioned between the actuator and the sealing ring.

19. An internal combustion engine metal casting mold assembly, comprising:
a mold core and mold cavity adapted to collectively form an internal combustion engine cylinder block;
a metallic cylinder wall lining sleeve having a hollow cylindrical shape and a chamfer or taper along a leading edge thereof;
a removable metallic bore pin of cylindrical shape, the bore pin having an outer diameter of a dimension that permits installation of the bore pin into the sleeve; and
a sealing ring encircling the outer diameter of the bore pin, the sealing ring residing at least partially within a circumferential groove in the outer diameter of the bore pin and arranged and dimensioned so as to be pressed against an inner wall of the sleeve in a sealing manner when the bore pin is installed into the sleeve;
wherein the bore pin is located within the sleeve and the sleeve is located within the casting mold during a casting operation and, upon completion of the casting operation, the bore pin and sealing ring are removed from the sleeve, which remains in the cast engine block; and
wherein the bore pin and sealing ring prevent flash from occurring within an interior of the sleeve during the casting operation.

20. The metal casting mold assembly of claim 19, wherein the sealing ring is of split design and includes interlocking elements at the location of the spilt, the interlocking elements permitting but limiting circumferential compression and expansion of the sealing ring.

21. The metal casting mold assembly of claim 19, further comprising an actuator that moves within an axial bore in the bore pin and is adapted to engage and circumferentially expand the sealing ring as the actuator is moved further into the bore pin, an actuator return mechanism located within the bore pin and adapted to move the actuator away from a position of sealing ring expansion.

22. The sleeve metal casting mold assembly of claim 21, further comprising a plurality of force transferring elements radially positioned between the actuator and the sealing ring.
